(19) United States
(12) Patent Application Publication
(10) Pub. No.: US 2008/0225922 A1
(43) Pub. Date: Sep. 18, 2008

(54) Rod-Type Solid-State Laser System

(76) Inventors: Shuichi Fujikawa, Tokyo (JP); Takafumi Kawai, Tokyo (JP); Junji Kano, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/590,191

(22) PCT Filed: Sep. 14, 2005
(86) PCT No.: PCT/JP2005/016933

§ 371 Date: Aug. 21, 2006

(51) Int. Cl. H01S 3/06

(52) U.S. Cl. 372/66

(57) ABSTRACT

In a symmetrically stable optical resonator, a first reference plane is set at an arbitrary position between the end face (102), opposing a partial reflector (2), and the neutral point (101) of a rod type solid state laser medium (1), and an aperture (5) having a diameter substantially equal to that of the rod type solid state laser medium (1) is arranged at a position optically symmetric to the reference plane with the partial reflector (2) as a neutral point using a relay lens (6) and a coupling lens (7) arranged between the aperture (5) and an optical fiber (8), the first reference plane is transfer-relayed onto the incident end face of the optical fiber (8), and the aperture (5) is transferred onto the coupling lens (7) through the relay lens (6). Even when the focal length of thermal lens of the rod type solid state laser medium (1) or pointing of laser light is varied, beam transmission is performed by an optical fiber excellent in stability and reliability and condensation of laser light exiting the optical fiber is sustained constantly.

### TECHNICAL FIELD

The present invention relates to a rod-type solid-state laser system that optically pumps a rod-type solid-state laser medium to generate a laser beam and make the laser beam enter an optical fiber so as to transmit the laser beam.

### BACKGROUND ART

A conventional rod-type solid-state laser system has been configured in such a way that, on the optical axis of a laser beam, an opening for limiting the beam diameter is provided, and the opening is transferred onto the incident endface of an optical fiber (e.g., refer to Patent Literatures 1 and 2).

[Patent Literature 1] Japanese Laid-Open Patent Publication 2003-78190 (paragraph 0022 to 0025, FIG. 1)
[Patent Literature 2] Japanese Laid-Open Patent Publication 2003-209307 (paragraph 0019, FIG. 1)

### DISCLOSURE OF THE INVENTION

In a conventional rod-type solid-state laser system that transmits a laser beam through an optical fiber, the power (focal length) of the thermal lens of the rod-type laser medium changes in accordance with laser output; therefore, the intrinsic mode changes that is decided in the optical resonator provided to extract a laser beam, whereby the collection angle of the laser beam that enters the optical fiber also changes in accordance with laser output. In the case where a step-refraction-index type optical fiber is utilized, the laser-beam collection angle is mostly maintained in the optical fiber; therefore, the divergence angle of the laser beam that exits from the optical fiber corresponds to the collection angle, thereby changing in accordance with laser output. In this situation, the collection angle of the laser beam that enters an optical fiber 8 and the divergence angle of the laser beam that exits from the optical fiber 8 are indicated by the angle α in FIG. 15. The beam-waist diameter of the laser beam that exits from the optical fiber is considered to be approximately equal to the core diameter of the optical fiber; therefore, the change in the divergence angle is equal to the change in the convergence. Accordingly, in a conventional rod-type solid-state laser system, the convergence of the laser beam that exits from the optical fiber changes in accordance with laser output.

As described above, in a conventional rod-type solid-state laser system, the divergence angle, i.e., the convergence of a laser beam that exits from an optical fiber changes in accordance with laser output; therefore, it has been a problem that, for example, in the case where, by coupling the emitting end of the optical fiber with the machining head formed of a condensing optical system, laser beams are utilized, the transmittance of a laser beam that passes through the machining head changes in accordance with laser output. Moreover, the diameter of a laser beam that enters the condensing optical system also changes in accordance with laser output; therefore, it has been a problem that the effect of aberration in the condensing optical system differs in accordance with laser output, whereby the diameter of the condensed laser beam also changes in accordance with laser output.

Still moreover, in a conventional rod-type solid-state laser system, no means for preventing the effect of pointing fluctuation in a laser beam has been provided; therefore, it has been a problem that, in the case where pointing fluctuation in a laser beam occurs, the collection angle, of a laser beam, for an optical fiber changes and the divergence angle of the laser beam that exits from the optical fiber is further enlarged, whereby the convergence is deteriorated. Furthermore, it has been a problem that, in the case where, due to the occurrence of pointing fluctuation, the collection angle, of a laser beam, for an optical fiber exceeds the allowable NA (Numerical Aperture) of the optical fiber, the laser beam leaks from the optical fiber, whereby the laser beam heats the connectors supporting both ends of the optical fiber or the protective layer coating the optical fiber, thereby damage them.

The present invention has been implemented, in order to solve the foregoing problems; the objective of the present invention is to provide a rod-type solid-state laser system in which, even in the case where the power of the thermal lens of the rod-type solid-state laser medium changes, the collection angle of a laser beam that enters an optical fiber is maintained to be approximately constant, and even in the case where the beam pointing of a laser beam varies, the damage to the optical fiber is prevented, whereby laser beams can stably be supplied.

The present invention provides a rod-type solid-state laser system in which, by means of a relay lens and a coupling lens, a laser beam emitted from a symmetric stable optical resonator consisting of a rod-type solid-state laser medium, a partially reflecting mirror, and a totally reflecting mirror is made to enter an optical fiber; the rod-type solid-state laser system is characterized in that a first reference plane is set at an arbitrarily position between the endface, of the rod-type solid-state laser medium arranged close to the partially reflecting mirror, that opposes the partially reflecting mirror and the middle point of the rod-type solid-state laser medium, a second reference plane is set at a position that is optically symmetric with the first reference plane, with respect to the partially reflecting mirror, the relay lens is arranged at a position at which the relay lens transfers the first reference plane onto a first image plane and transfers-the second reference plane onto the coupling lens, and the coupling lens is arranged at a position at which the coupling lens transfers the first image plane onto the endface of the optical fiber.

Because a rod-type solid-state laser system according to the present invention is configured as described above, even in the case where the focal length of the thermal lens of the rod-type solid-state laser medium varies. the respective beam diameters and the respective beam positions on the coupling lens and the incident endface of the optical fiber are maintained to be approximately constant, whereby not only stable and high-reliability beam transmission through the optical fiber is enabled, but also the convergence of a laser beam that exits from the optical fiber can be maintained to be approximately constant.

### BRIEF DESCRIPTION OF THE DRAWINGS

FIG. 1 is a schematic diagram illustrating the configuration of a rod-type solid-state laser system according to Embodiment 1 of the present invention;

FIG. 2 is a schematic diagram illustrating a rod-type solid-state laser medium according to Embodiment 1 of the present invention;

FIG. 3 is a configuration diagram illustrating a symmetric stable optical resonator configured by arranging a partially reflecting mirror formed of a plane mirror and a totally reflecting mirror, for a rod-type solid-state laser medium according to Embodiment 1 of the present invention;

FIG. 4 is a configuration diagram illustrating a symmetric stable optical resonator that, by means of two equivalent thermal lenses, represents and is optically equivalent to a symmetric stable optical resonator according to Embodiment 1 of the present invention;

FIG. 5 is a configuration diagram illustrating a symmetric stable optical resonator that, by means of a single equivalent thermal lens, represents and is optically equivalent to a symmetric stable optical resonator according to Embodiment 1 of the present invention;

FIG. 6 is an explanatory diagram for explaining the mode shape, i.e., the beam propagation condition, of a laser beam in a symmetric stable optical resonator according to Embodiment 1 of the present invention;

FIG. 7 is a explanatory diagram illustrating the mode shape, i.e., the beam propagation condition, of a laser beam in a symmetric stable optical resonator that, by means of a single equivalent thermal lens, represents and is optically equivalent to a symmetric stable optical resonator according to Embodiment 1 of the present invention;

FIG. 8 is a graph representing the beam propagation condition of a laser beam in an optical system designed based on Embodiment 1 of the present invention;

FIG. 9 is a graph representing the collection angle, of a laser beam entering an optical fiber, versus the laser output, in Embodiment 1 of the present invention;

FIG. 10 is a schematic diagram illustrating the configuration of a rod-type solid-state laser system according to Embodiment 2 of the present invention;

FIG. 11 is a schematic diagram illustrating the configuration of a rod-type solid-state laser system according to Embodiment 3 of the present invention;

FIG. 12 is a schematic diagram illustrating the configuration of a rod-type solid-state laser system according to Embodiment 4 of the present invention;

FIG. 13 is a schematic diagram illustrating the configuration of a rod-type solid-state laser system according to Embodiment 5 of the present invention;

FIG. 14 is a schematic diagram illustrating the configuration of a rod-type solid-state laser system according to Embodiment 6 of the present invention; and

FIG. 15 is a diagram for explaining the collection angle of a laser beam entering an optical fiber.

### BEST MODE FOR CARRYING OUT THE INVENTION

### EMBODIMENT 1

FIG. 1 is a schematic diagram illustrating the configuration of a rod-type solid-state laser system according to Embodiment 1 of the present invention. In FIG. 1, Reference Numeral 1 designates rod-type solid-state laser medium; Reference Numeral 101, the middle point of the rod-type solid-state laser medium 1; and Reference Numeral 102, an endface of the rod-type solid-state laser medium 1. In Embodiment 1, as the rod-type solid-state laser medium 1, a YAG (a yttrium-aluminum garnet) crystal is utilized in which, as an active medium, Nd (Neodymium) is doped. Reference Numeral 2 designates a partially reflecting mirror; Reference Numeral 3, a totally reflecting mirror; and Reference Numeral 4, a laser beam. The partially reflecting mirror 2 and the totally reflecting mirror 3 configure an optical resonator; a laser beam is extracted from the rod-type solid-state laser medium 1 that is optically pumped by means of a lamp light source or a semiconductor laser. Reference Numeral 5 designates an aperture that is arranged in the optical path of the laser beam 4 and has the same opening diameter as the diameter of the rod-type solid-state laser medium 1. Reference Numeral 6 designates a relay lens of a focal length f1; and Reference Numeral 7, a coupling lens of a focal length f2. Reference Numeral 8 designates an optical fiber; and Reference Numeral 81, an incident endface of the optical fiber 8. The laser beam 4 that has passed through the aperture 5 is transmitted through the relay lens 6 to the coupling lens 7. The laser beam 4 that has been transmitted to the coupling lens 7 is condensed by the coupling lens and through the incident endface of the optical fiber 8, enters the optical fiber 8. Reference Numeral 9 designates an equivalent thermal lens, indicated by a dotted line, that represents a thin-wall lens optically equivalent to the thermal-lens component corresponding to the half portion, of the pumped rod-type solid-state laser medium 1, closer to the partially reflecting mirror 2 with respect to the middle point 101; and Reference Numeral 10, the first image plane of a first transfer optical system described later.

In Embodiment 1, the partially reflecting mirror 2 formed of a plane mirror and the totally reflecting mirror 3 are utilized; by arranging the partially reflecting mirror 2 and the totally reflecting mirror 3 at the corresponding positions that are Lm apart from the respective endfaces of the rod-type solid-state laser medium 1, a symmetric stable resonator is configured. Accordingly, in the case where the rod-type solid-state laser medium 1 is pumped ideally in a homogeneous fashion, the symmetry of the beam mode within the optical resonator is ensured, with respect to the middle point 101 of the rod-type solid-state laser medium 1

In addition, in Embodiment 1, the aperture 5. having the same opening diameter as the diameter of the rod-type solid-state laser medium 1 is arranged at the position that is a distance L1 apart from the partially reflecting mirror 2; the relay lens 6 of a focal length f1, at the position that is a distance L2 apart from the aperture 5; the coupling lens 7 of a focal length f2, at the position that is a distance L3+L4 apart from the relay lens 6; and the incident endface 81 of the optical fiber 8, at the position that is a distance L5 apart from the coupling lens 7. Additionally, the position of the main plane of the equivalent thermal lens 9 is situated at the position that is a distance Ltl apart from the endface 102 of the rod-type solid-state laser medium 1.

In Embodiment 1, the relay lens 6 and the coupling lens 7 configure the first transfer optical system; firstly, the relay lens 6 transfers the main plane of the equivalent thermal lens 9 onto the first image plane 10; secondly, the coupling lens 7 transfers the first image plane 10 onto the incident endface 81 of the optical fiber 8 as a second image plane. In consequence, the rod-type solid-state laser system according to Embodiment 1 is configured in a transfer relay fashion. Accordingly, assuming that the refraction index of the rod-type solid-state laser medium 1 is n, and by converting the distance Ltl between the rod endface 102 and the main plane of the equivalent thermal lens 9 into an optical distance, the first transfer optical system conforms to the relationships given by Equations (1) and (2).

$$\begin{matrix}\frac{1}{f 1} = \frac{1}{\frac{Ltl}{n} + Lm + L 1 + L 2} + \frac{1}{L 3} & ( 1 ) \\ \frac{1}{f 2} = \frac{1}{L 4} + \frac{1}{L 5} & ( 2 )\end{matrix}$$

Additionally, in Embodiment 1, the relay lens 6 is included in a second transfer optical system; the relay lens 6 transfers the aperture 5 onto the coupling lens 7. Therefore, the second transfer optical system conforms to the relationship given Equation (3).

$$\frac{1}{f 2} = \frac{1}{L 2} + \frac{1}{L 3 + L 4} \qquad ( 3 )$$

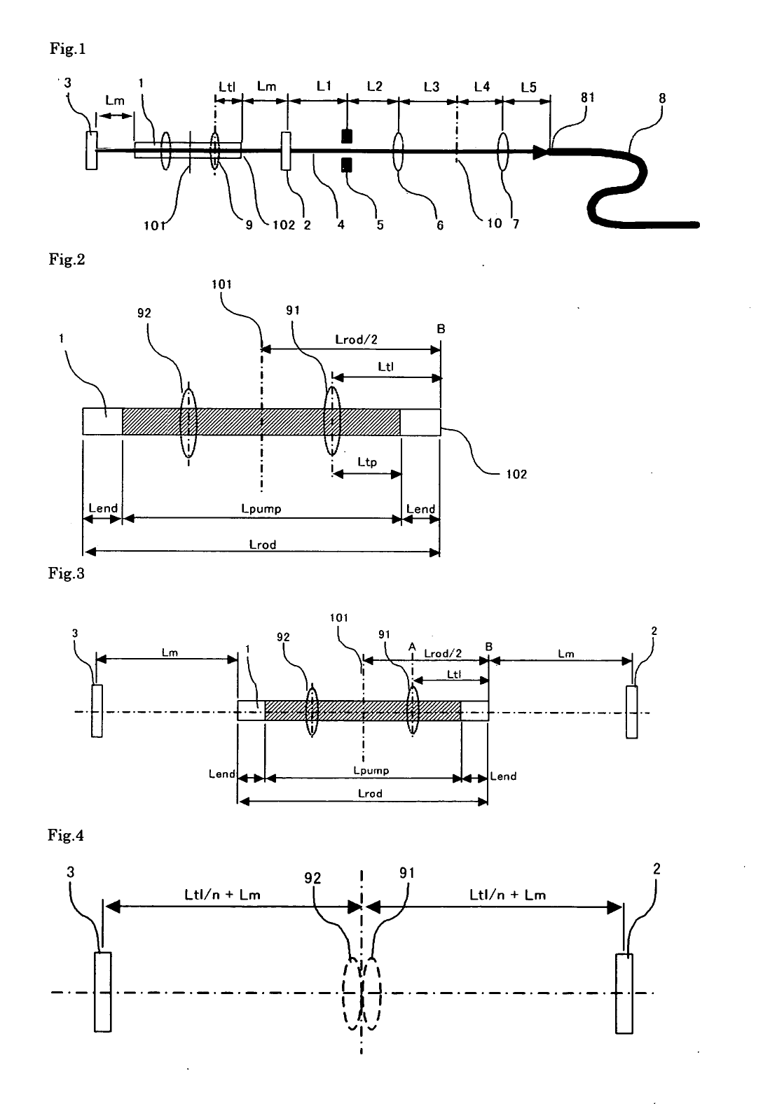

Next, with reference to a schematic diagram, in FIG. 2, of the rod-type solid-state laser medium 1, the thermal lens, of the rod-type solid-state laser medium 1, that plays an important role in Embodiment 1 will be explained in detail. In FIG. 2, Reference Numeral 91 designates a thin-wall lens, indicated by a dotted line, that is optically equivalent to the thermal-lens component corresponding to the right half portion, of the pumped rod-type solid-state laser medium 1, with respect to the middle point 101; and Reference Numeral 92 designates a thin-wall lens that is optically equivalent to the thermal-lens component corresponding to the left half portion, of the pumped rod-type solid-state laser medium 1, with respect to the middle point 101. In addition, the hatched area indicated by a length Lpump represents a pumping region in which pumped light is irradiated by means of a discharge lamp or a semiconductor laser; and both the endface portions, of the rod-type solid-state laser medium 1, each indicated by a length Lend represent non-pumping regions. Here, for the sake of brevity, an ideal condition is assumed in which the pumping density in the pumping region is homogeneous.

The thermal lens of the rod-type solid-state laser medium 1 is generated by temperature distribution formed, within the cross section of the rod-type solid-state laser medium 1, due to heat generation, in the rod-type solid-state laser medium 1 itself, that is caused by pumping. When the rod-type solid-state laser medium 1 is pumped, a mount-shaped temperature distribution is formed in which, within the cross section of the rod-type solid-state laser medium 1, the temperature is high in the middle portion and low in the peripheral portion. Because the, refraction index of the rod-type solid-state laser medium 1 is approximately proportional to the temperature, the refraction-index distribution caused by the temperature distribution presents convergence action. The convergence action is a phenomenon referred to as a thermal lens. With regard to Embodiment 1, in the first place, the thermal lens of the right half portion, of the rod-type solid-state laser medium 1, with respect to the middle point 101 in FIG. 2 will be considered.

The thermal lens of the right half portion, of the rod-type solid-state laser medium 1, with respect to the middle point 101 has a thickness of Lpump/2. The thermal lens having a significant thickness is replaced by a thin-wall lens, i.e., the equivalent thermal lens 91, indicated by a dotted line, that is optically equivalent to the thermal lens and has the same focal length as that of the thermal lens. When, in the pumping region, the pumping density is homogeneous, the main plane of the equivalent thermal lens 91 is situated at the middle point of the significant-length real thermal lens of the right half portion of the rod-type solid-state laser medium 1. Accordingly, the distance, indicated by Ltp, between the end of the pumping region and the main plane of the equivalent thermal lens 91 is given Equation (4).

$$Ltp = \frac{Lpump}{4} \qquad ( 4 )$$

Accordingly, the distance LT1 between the position B of the endface of the rod-type solid-state laser medium 1 and the main plane of the equivalent thermal lens 91 is given by Equations (5), by utilizing the rod length Lrod and the length Lpump of the pumping region.

$$Ltl = \frac{Lrod}{2} - \frac{Lpump}{4} \qquad ( 5 )$$

In addition, in FIG. 2, Reference Numeral 92 designates the equivalent thermal lens of the left half portion, of the rod-type solid-state laser medium 1, with respect to the middle point 101.

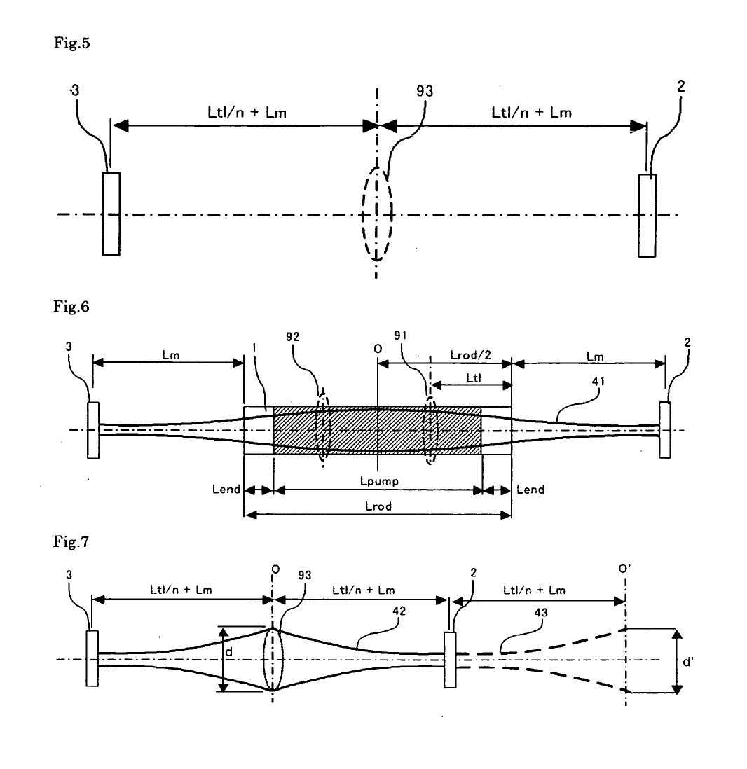

FIG. 3 illustrates the configuration of a symmetric stable optical resonator in which, for the rod-type solid-state laser medium 1 illustrated in FIG. 2, the partially reflecting mirror 2 formed of a plane mirror and the totally reflecting mirror 3 are arranged at the corresponding positions that are Lm apart from the respective endfaces of the rod-type solid-state laser medium 1. FIG. 4 illustrates a symmetric stable optical resonator that, by means of the equivalent thermal lenses 91 and 92, represents and is optically equivalent to the symmetric stable optical resonator illustrated in FIG. 3. As illustrated in FIG. 4, in the symmetric stable optical resonator represented by means of the equivalent thermal lenses 91 and 91, both the equivalent thermal lenses 91 and 91 are situated at the middle point of the symmetric stable optical resonator. As illustrated in FIG. 5, the equivalent thermal lenses 91 and 92 that are arranged at the same position and have the same focal length can be replaced by a single thin-wall lens 93 having half as long focal length as those of the equivalent thermal lenses 91 and 92. The optical distance between the main plane of the thin-wall lens 93 illustrated in FIG. 5 and the partially reflecting mirror 2 and the optical distance between the main plane of the thin-wall lens 93 and the totally reflecting mirror 3 are equal to the optical distance between the main plane of the equivalent thermal lens 91 and the partially reflecting mirror 2 and the optical distance between the main plane of the equivalent thermal lens 92 and the totally reflecting mirror 3, respectively, and each represent a free space of a length Ltl/n+Lm when the refraction index n of the rod-type solid-state laser medium 1 is considered.

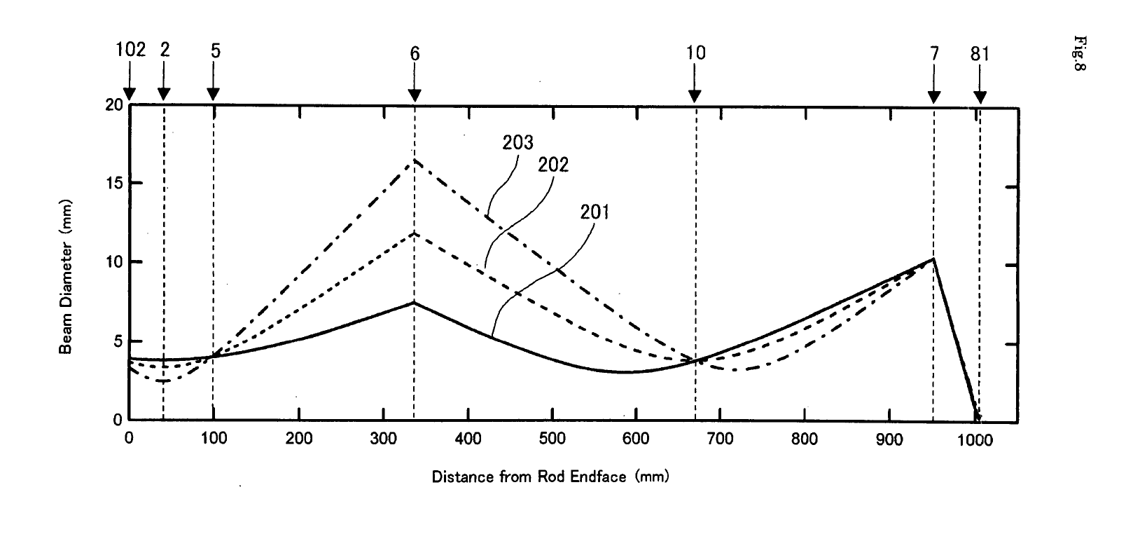

FIG. 6 illustrates the mode shape of a laser beam, i.e., the state of beam propagation, in the symmetric stable optical resonator illustrated in FIG. 3. In FIG. 6, Reference Numeral 41 designates the beam outline shape of a laser beam in the symmetric stable optical resonator. FIG. 7 illustrates the mode shape of a laser beam, i.e., the state of beam propagation, in the symmetric stable optical resonator obtained through replacing the thermal lens, of the rod-type solid-state laser medium 1 illustrated in FIG. 5, by a optically equivalent thin-wall lens. In FIG. 7, Reference Numeral 42 designates the beam outline shape of a laser beam in the symmetric stable optical resonator; and Reference Numeral 43 designates the beam outline shape of a laser beam that exits from the partially reflecting mirror 2. In an ideal symmetric stable optical resonator in which the rod-type solid-state laser medium 1 is pumped homogeneously, the symmetry of the mode with respect to the middle point of the resonator is ensured. In addition, in each of the symmetric stable optical resonators illustrated in FIGS. 6 and 7, plane mirrors are utilized as the partially reflecting mirror 2 and the totally reflecting mirror 3; therefore, because of the boundary condition for an optical resonator, it is certain that the respective laser-beam wavefronts on the partially reflecting mirror 2 and the totally reflecting mirror 3 become planar. In other words, it is certain that, on each of the partially reflecting mirror 2 and the totally reflecting mirror 3, a beam waist is formed. As a result, in each of the symmetric stable optical resonators illustrated in FIGS. 6 and 7, the beam diameter becomes maximal at the middle point. As illustrated in FIG. 6, in the actual symmetric stable optical resonator, the middle point O of the resonator is located at the middle point 101 inside the rod-type solid-state laser medium 1. Accordingly, the opening diameter that limits the beam diameter in the symmetric stable optical resonator is approximately equal to the diameter of the rod-type solid-state laser medium 1. In the pumping medium, because of transverse multimode oscillation, the diameter of a laser beam spreads fully up to the opening diameter. Accordingly, even in the case where the thermal-lens power. i.e., the thermal-lens focal length, of the rod-type solid-state laser medium 1 changes, the laser-beam diameter at the middle point 101 of the rod-type solid-state laser medium 1 is maintained to be approximately the same as the diameter of the rod-type solid-state laser medium 1. In other words, in FIG. 7, even if the thermal-lens focal length changes, the beam diameter don the main plane of the thin-wall lens 93 is maintained to be approximately the same as the diameter of the rod-type solid-state laser medium 1.

In addition, as described above, because, in Embodiment 1, a plane mirror is utilized as the partially reflecting mirror 2, it is certain that, on the partially reflecting mirror 2, a beam waist is formed. Because, in a free space, the symmetry, of a beam diameter, before and after a beam waist is ensured, as illustrated in FIG. 7, the diameter d′ of the beam that has exited from the partially reflecting mirror 2 and is situated at the position O′ that is by the distance Ltl/n+Lm apart from the partially reflecting mirror 2 is equal to the beam diameter d at the middle point of the resonator. In consequence, regardless of the condition of the thermal lens of the rod-type solid-state laser medium 1, the diameter d′ of the beam that has exited from the partially reflecting mirror 2 and is situated at the position O′ that is by the distance Ltl/n+Lm apart from the partially reflecting mirror 2 is also always maintained to be approximately equal to the diameter of the rod-type solid-state laser medium 1.

Here, an object plane in the first transfer optical system will be referred to as a first reference plane. It is desirable that on the first reference plane, the diameter of a laser beam is approximately constant, regardless of the condition of the thermal lens of the rod-type solid-state laser medium. Thus, in Embodiment 1, the main plane of the equivalent thermal lens 91 in the rod-type solid-state laser medium 1 is set as the first reference plane. Additionally, a position that is optically symmetric with the first reference plane, with respect to the partially reflecting mirror 2, will be referred to as a second reference plane. In Embodiment 1, the second reference plane falls on the position O′, in FIG. 7, where the laser-beam diameter is maintained to be approximately equal to the laser-beam diameter on the first reference plane. In Embodiment 1, the aperture 5 is arranged on the second reference plane.

In Embodiment 1 illustrated in FIG. 1, as described above, the partially reflecting mirror 2 and the aperture 5 are arranged in such a way as to be spaced Ltl/n+Lm apart from each other. That is to say, Equation (6) is yielded.

$$L 1 = \frac{Ltl}{n} + Lm = \frac{Lrod / 2 + Lpump / 4}{n} + Lm \qquad ( 6 )$$

In consequence, regardless of the condition of the thermal lens of the rod-type solid-state laser medium 1, the laser-beam diameter at the aperture 5 is always maintained to be approximately equal to the diameter of the rod-type solid-state laser medium 1.

In Embodiment 1, the rod-type solid-state laser system is configured in such a way that, by utilizing the first transfer optical system, the main plane of the equivalent thermal lens 91 in the rod-type solid-state laser medium 1 is transferred onto the incident endface 81 of the optical fiber 8. It is ensured that, on the main plane, of the equivalent thermal lens 91, that corresponds to the object plane of the first transfer optical system, regardless of the condition of the thermal lens, the beam diameter is maintained to be approximately the same as the diameter of the rod-type solid-state laser medium 1, and that the beam exists within the rod-type solid-state laser medium 1; therefore, regardless of the condition of the thermal lens of the rod-type solid-state laser medium 1, the laser-beam position as well as the diameter on the incident endface 81, of the optical fiber 8, that is the image plane in the first transfer optical system is always maintained to be constant.

The transfer magnification M1, of the first transfer optical system, in Embodiment 1 is given by Equation (7), by utilizing respective distances between the optical elements.

$$M 1 = \frac{L 3}{\frac{Ltl}{n} + Lm + L 1 + L 2} \times \frac{L 5}{L 4} \qquad ( 7 )$$

In general, the value of the transfer magnification M1 of the first transfer optical system may appropriately be decided in accordance with the diameter of the rod-type solid-state laser medium 1 and the core diameter of the optical fiber 8 to be utilized. For example, in the case where the rod-type solid-state laser medium 1 of a diameter 5 mm and the optical fiber 8 of a core diameter 0.4 mm are utilized, and a laser beam is made to enter the optical fiber 8 on the basis of 90% criterion versus the core diameter of the optical fiber 8, the transfer magnification M1 of the first transfer optical system is 0.072.

In addition, in Embodiment 1, the rod-type solid-state laser system is configured in such a way that the aperture 5 having the same opening diameter as the diameter of the rod-type solid-state laser medium 1 is arranged at the position that, with reference to the partially reflecting mirror 2, is optically symmetric with the main plane of the equivalent thermal lens 91 of the rod-type solid-state laser medium 1, and the aperture 5 is transferred onto the coupling lens 7, by means of the second transfer optical system. In consequence, regardless of the condition of the thermal lens of the rod-type solid-state laser medium 1, the beam diameter at the aperture 5 is maintained to be approximately equal to the diameter of the rod-type solid-state laser medium 1. Accordingly, in the case where no pointing fluctuation exists in the laser beam 4 that exits from the partially reflecting mirror 2, the beam diameter of a laser beam that passes through the aperture 5 is approximately constant, regardless of existence of the aperture 5. As a result, regardless of the condition of the thermal lens of the rod-type solid-state laser medium 1, the position and the diameter of a laser beam on the coupling lens 7, which is the image plane in the second transfer optical system, can be ensured. In addition, in the case where any pointing fluctuation exists in the laser beam 4 that exits from the partially reflecting mirror 2, the laser beam 4 situated outside the opening of the aperture 5 does not pass through the aperture 5; therefore, regardless of the pointing fluctuation, the laser beam that passes through the aperture 5 always stays within the opening of the aperture 5. Accordingly, the laser-beam irradiation coverage on the coupling lens 7, which is the image plane in the second transfer optical system, is always within the irradiation coverage in the case where no pointing fluctuation exists. Therefore, the collection angle of a laser beam that enters the optical fiber 8 is also maintained at an approximately constant value.

Meanwhile, in the foregoing description, a configuration has been explained in which, by arranging an aperture on the object plane, of the second transfer optical system, that is the second reference plane, the beam position is physically limited. However, as described above, in the case where no pointing fluctuation exists, regardless of the existence of the aperture and the condition of the thermal lens, the beam diameter on the coupling lens 7 becomes approximately constant; therefore, for example, as long as the pointing fluctuation is small and the fluctuation in the collection angle of a laser beam that enters the optical fiber is within a tolerance range, the rod-type solid-state laser system may be configured in such a way that no aperture is arranged on the object plane of the second transfer optical system. This can also be applied to the following embodiments.

In addition, the transfer magnification M2, of the second transfer optical system, in Embodiment 1 is given by Equation (8), by utilizing respective distances between the optical elements.

$$M 2 = \frac{L 3 + L 4}{L 2} \qquad ( 8 )$$

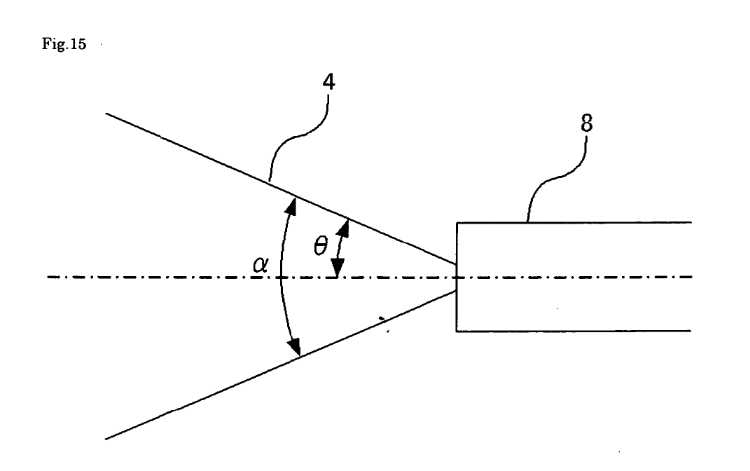

Additionally, in general, the value of the transfer magnification M2 of the second transfer optical system may appropriately be decided in accordance with a desired beam collection angle for the optical fiber 8. For example, in the case where it is required to make the distance L5 between the coupling lens 7 and the incident endface 81 of the optical fiber 8 be 50 mm and the collection angle for the optical fiber 8 be 0.20 rad, it is possible to make the collection angle approximately 0.20 rad, if the diameter of the incident beam to the coupling lens 7 is made 10 mm. In this situation, if the diameter d of the rod-type solid-state laser medium is made to be 5 mm, the diameter d′ on the second reference plane or the opening diameter of the aperture 5 becomes 5 mm, the value of the transfer magnification M2 of the second transfer optical system may be set at 2.0. Assuming that, as illustrated in FIG. 15, the half angle of the collection angle is θ, the relationship is given by Equation (9).

$$M 2 = \frac{2 \times L 5 \times tan θ}{d} \qquad ( 9 )$$

In this situation, the equations that decide the arrangement of the lenses and the like include seven equations, i.e., Equations (1), (2), (3), (7), (8), (9), and (10) that gives an overall length L of the optical system.

L=L1+L2+L3+L4+L5 (10)

By solving the equations, based on various kinds of preconditions, the respective appropriate positions for the relay lens and the coupling lens can be computed. For example, assuming that the configuration of the resonator is known, Ltl, n, Lm, and L1 are known constants. In addition, if the size of the laser oscillator is also specified, L is also a known constant. Moreover, because the respective diameters of the solid-state laser medium and the optical fiber are known in general, the transfer magnification of the first transfer optical system is also a known constant. Accordingly, in this situation, variables are L2, L3, L4, L5, f1, f2, and M2, and they can be decided in accordance with the above seven equations. Additionally, for example, in the case where it is required to fix the focal lengths f1 and f2 so as to make the coupling lens and the relay-lens be shared with other laser systems, by, in order to give freedom to the length of the optical system, deleting Equation (10) or by, in order to give freedom to the configuration of the resonator, making Ltl and Lm variables, the arrangement of each lens can be decided.

FIG. 8 is a graph representing beam-propagation conditions in an optical system designed based on Embodiment 1; the ordinate denotes the beam diameter; and the abscissa, the distance from the endface 102 of the rod-type solid-state laser medium 1. In FIG. 8, Reference Numeral 201 designates a curve representing the beam diameter in the case of low output power, i.e., in the case where the focal length of the thermal lens is relatively long; Reference Numeral 202, a curve representing the beam diameter in the case of medium output power, i.e., in the case where the focal length of the thermal lens is medium; and Reference Numeral 203, a curve representing the beam diameter in the case of high output power, i.e., in the case where the focal length of the thermal lens is relatively short. The design example in FIG. 8 represents beam-propagation conditions in the optical system in the case where the rod-type solid-state laser medium 1 of a diameter 4 mm is utilized; it can be seen that, regardless of the condition of the thermal lens, the beam diameter at the aperture 5 is approximately equal to the diameter of the rod-type solid-state laser medium 1, i.e., 4 mm. Additionally, also on the first image plane 10 of the first transfer optical system and on the coupling lens 7, the beam diameter is constant, regardless of the condition of the thermal lens. The diameter of an incident beam on the coupling lens 7 is always constant, regardless of the condition of the thermal lens; therefore, the collection angle of the laser beam that enters the optical fiber 8 is also maintained at an approximately constant value.

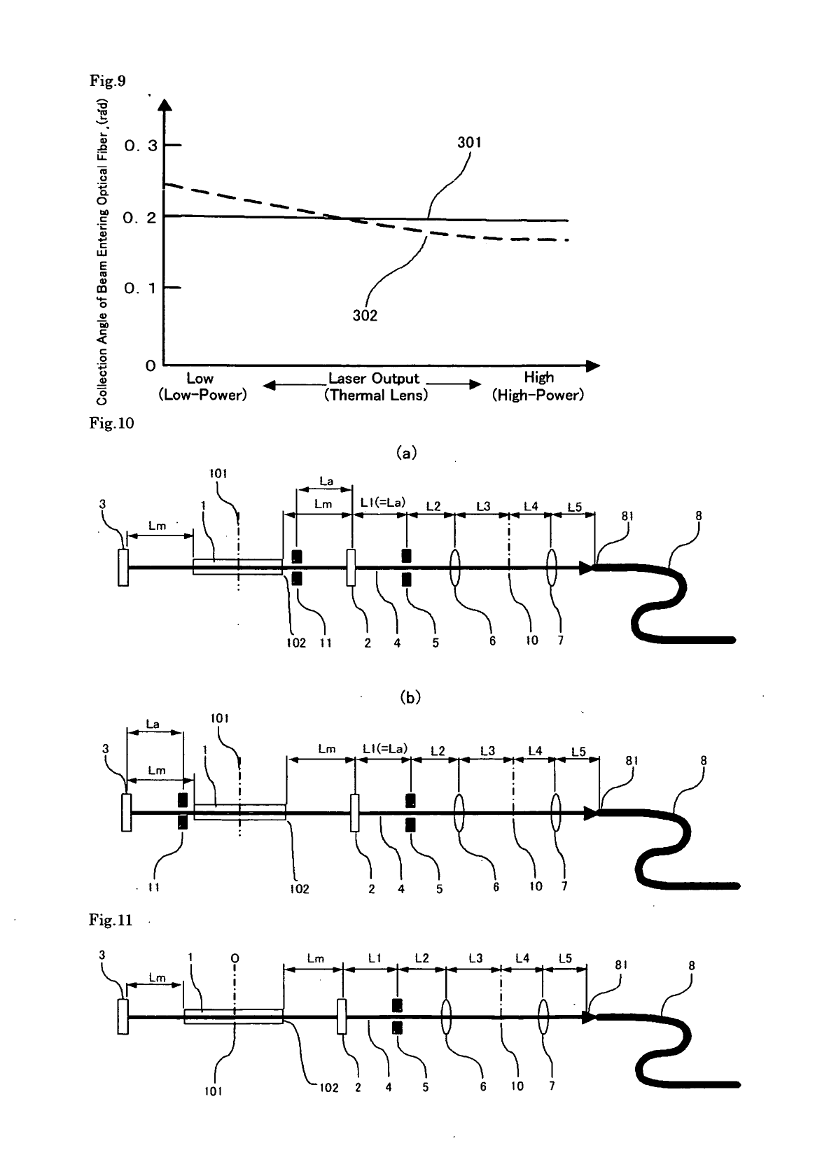

FIG. 9 is a graph representing the beam collection angle, for an optical fiber, versus the laser output. In FIG. 9, Reference Numeral 301 represents the beam collection angle in the case of an optical system designed based on Embodiment 1; and Reference Numeral 302, the beam collection angle in the case of a conventional optical system. In the case of the conventional optical-system design, with increase in the laser output, the beam collection angle for the optical fiber decreases; in contrast, in the case of the optical system based on Embodiment 1, regardless of the laser output, the beam collection angle for the optical fiber is maintained to be approximately constant. In the case where a step-index (SI) type optical fiber is utilized, ideally even in the optical fiber, the beam divergence angle is maintained; therefore, by, based on Embodiment 1, designing an optical system, the laser beam that exits the optical fiber 8 can also maintain an approximately constant convergence, regardless of the laser output level.

In Embodiment 1, a method has been described in which, under the ideal condition with assumption that the pumping region is explicitly specified and the pumping density is homogeneous in the pumping region, the thermal lens of the rod-type solid-state laser medium 1 is anticipated and the arrangement for the optical system is decided. However, when the rod-type solid-state laser medium 1 is practically pumped by means of a discharge lamp or a semiconductor laser, the boundary between the pumping region and the non-pumping region is not clear, due to reflection and dispersion, of the pumped beam, in the rod-type solid-state laser medium 1. The computing method, described in Embodiment 1, for the main plane of the thermal lens is nothing but estimation; thus, the main. plane of the equivalent thermal lens, i.e., the first reference plane may be set in the vicinity of the position given by Equation (5). For instance, even in the case where, within the range between the endface 102 of the rod-type solid-state laser medium 1 and the middle point 101, the thermal-lens main plane as the first reference plane is arbitrarily set, the same effect can be demonstrated. The point is that the second reference plane is set at the position optically symmetric with the set main plane of the equivalent thermal lens, with respect to the partially reflecting mirror 2, whereby the main plane of the equivalent thermal lens 9 is transfer-relayed by means of the first transfer optical system consisting of the relay lens 6 and the coupling lens 7 to the incident endface 81 of the optical fiber 8 and the second reference plane is transferred by means of the second transfer optical system formed of the relay lens 6 onto the coupling lens 7. As may be necessary, the aperture 5 having the same opening diameter as the diameter of the rod-type solid-state laser medium 1 may be arranged on the second reference plane.

In addition, in Embodiment 1, an example has been described in which, by utilizing the relay lens and the coupling lens, the first and second transfer optical systems are configured, respectively; however, the lenses to be included in the first and second transfer optical systems are not limited to the two lenses, i.e., a relay lens and a coupling lens. For example, also by considering an equivalent lens formed through combination of two lenses to be a relay lens and configuring the first and second transfer optical systems, the same effect as that of Embodiment 1 can be demonstrated; moreover, because change in the distance between the two lenses included in the relay lens is optically equivalent to change in the focal length of the relay lens, the optical-path length can readily be changed, while maintaining the respective transfer magnifications of the first and second transfer optical systems to be constant. Additionally, in Embodiment 1, a configuration has been described in which a single lens is utilized as the coupling lens; however, even when a combination lens is utilized as the coupling lens, not only the same effect can be demonstrated, but also the effect of spherical aberration is reduced, whereby the adjustment margin for an incident beam to the optical fiber can be increased. Also in each of the following embodiments, a system will be explained in which the relay lens and the coupling lens are each formed of a single lens; however, as described above, the relay lens and the coupling lens may each be configured of a plurality of lenses.

### EMBODIMENT 2

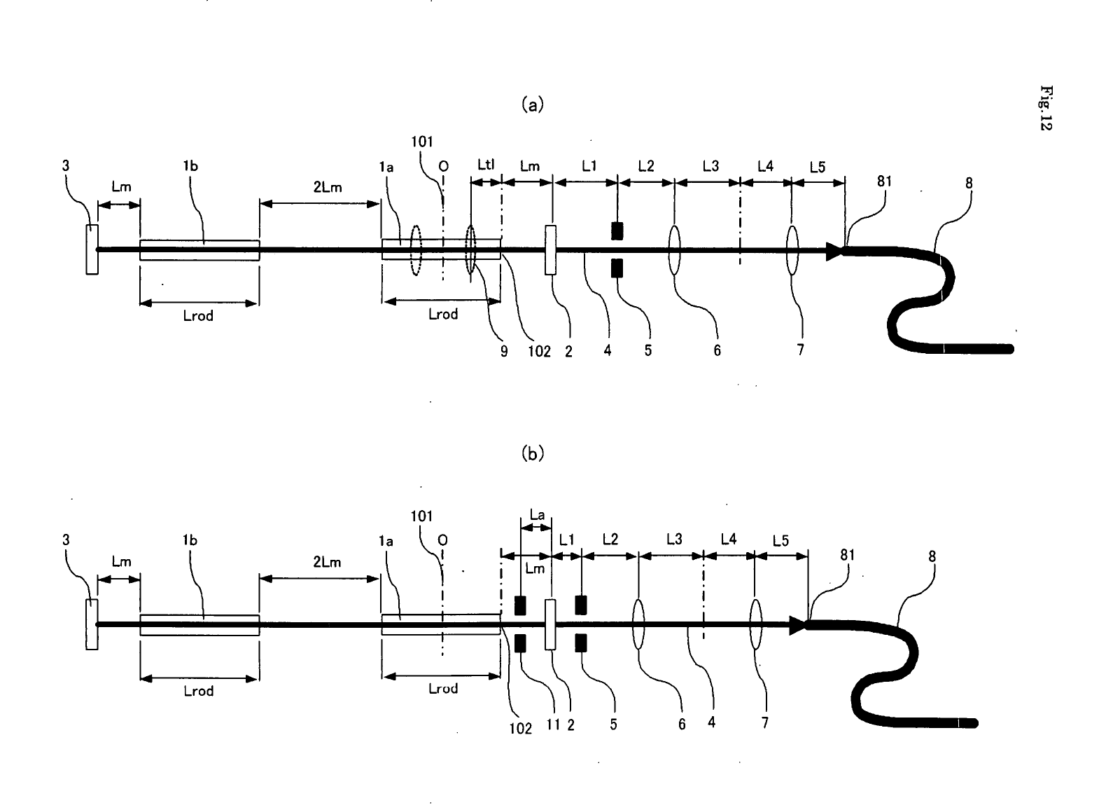

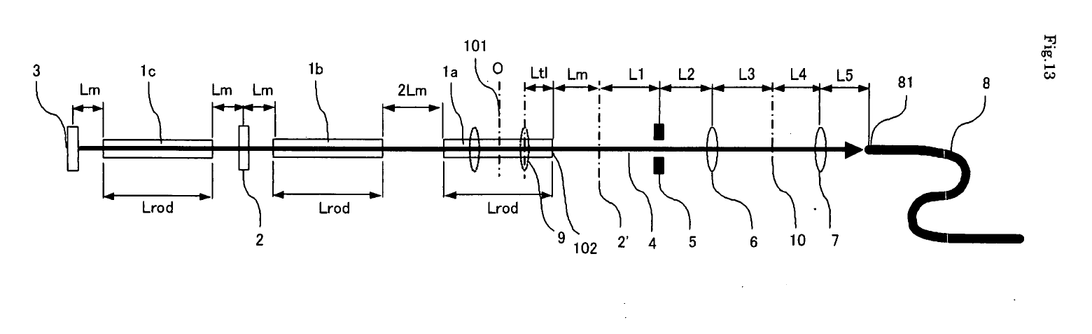

FIG. 10 (a) is a schematic view illustrating the configuration of a rod-type solid-state laser system according to Embodiment 2 of the present invention. In FIG. 10 (a), Reference Numeral 11 designates an internal aperture arranged a distance La apart from the partially reflecting mirror 2, inside the optical resonator. In Embodiment 2, the internal aperture 11 limits the diameter, i.e., the so-called transverse mode, of a laser beam within the optical resonator. Accordingly, regardless of the condition of the thermal lens of the rod-type solid-state laser medium 1, the position and the diameter of a laser beam at the internal aperture 11 are maintained to be constant. In other words, the first reference plane in Embodiment 2 falls on the position of the internal aperture 11.

In Embodiment 2, the aperture 5 having the same opening diameter as the diameter of the internal aperture 11 is arranged at the position that, with reference to the partially reflecting mirror 2, is optically symmetric with the internal aperture 11, i.e., at the second reference plane. In other words, Equation (11) is yielded.

L1=La (11)

Because of the boundary condition for an optical resonator, it is ensured that a beam waist is formed on the partially reflecting mirror 2; therefore, due to symmetry in beam propagation, also at the aperture 5, regardless of the condition of the thermal lens of the rod-type solid-state laser medium 1, the position and the diameter of a laser beam are maintained to be approximately constant.

In addition, as is the case with Embodiment 1, in Embodiment 2, the relay lens 6 and the coupling lens 7 configure the first transfer optical system. However, in Embodiment 2, the internal aperture 11 is set as an object plane; in the first place, the internal aperture 11 is transferred onto the first image plane 10, by means of the relay lens 6. As is the case with Embodiment 1, the coupling lens 7 relays in a contraction transfer fashion the first image plane 10 to the incident endface 81 of the optical fiber 8. Additionally, in Embodiment 2, the internal aperture 11 is set as the object plane of the first transfer optical system; therefore, Equation (1), described in Embodiment 1, that gives the image-formation condition on the first image plane is modified into Equation (10′).

$$\frac{1}{f 1} = \frac{1}{La + L 1 + L 2} + \frac{1}{L 3} \qquad ( {1}^{′} )$$

In addition, Equation (2) can be applied also to Embodiment 2. Additionally, in Embodiment 2, as is the case with Embodiment 1, the relay lens 6 is included in the second transfer optical system; the relay lens 6 transfers the aperture 5 onto the coupling lens 7. Therefore, the relationship represented in Equation (3) in Embodiment 1 can directly be applied to Embodiment 2.

In Embodiment 2, the transfer magnification M1 of the first transfer optical system is given by Equation (7′).

$$M 1 = \frac{L 3}{La + L 1 + L 2} \times \frac{L 5}{L 4} \qquad ( {7}^{′} )$$

Additionally, as is the case with Embodiment 1, the transfer magnification M2 of the second transfer optical system can be computed in accordance with Equation (8). In accordance with the opening diameter of the internal aperture 11, the transfer magnification M1 of the first transfer optical system and the transfer magnification M2 of the second transfer optical system may be set at respective appropriate values for the beam diameter on the incident endface 81 of the desired optical fiber 8 and the beam collection angle for the optical fiber 8.

In Embodiment 2, the internal aperture 11 ensures the beam diameter and the beam position on the object plane in the first transfer optical system; therefore, regardless of the condition of the thermal lens of the rod-type solid-state laser medium 1, the laser-beam position as well as the diameter, of the laser beam 4, on the incident endface 81, of the optical fiber 8, that is the image plane in the first transfer optical system is always maintained to be constant.

In addition, in Embodiment 2, the rod-type solid-state laser system is configured in such a way that the aperture 5 having the same opening diameter as the diameter of the internal aperture 11 is arranged at the position that, with reference to the partially reflecting mirror 2, is optically symmetric with the internal aperture 11 that is on the first reference plane, i.e., at the second reference plane, and the aperture 5 is transferred onto the coupling lens 7, by means of the second transfer optical system. In consequence, regardless of the condition of the thermal lens of the rod-type solid-state laser medium 1, the beam diameter at the aperture 5 is maintained to be approximately equal to the diameter of the rod-type solid-state laser medium 11, and the laser beam 4 situated outside the opening of the aperture 5 cannot passes through the aperture 5; therefore, even in the case where pointing fluctuation or the like exists in the laser beam 4 that exits from the partially reflecting mirror 2, the beam diameter and the position of the laser beam on the coupling lens 7 that is on the image plane of the second transfer optical system are ensured. As a result, regardless of. the condition of the thermal lens of the rod-type solid-state laser medium 1, the collection angle of the laser beam 4 that enters the optical fiber 8 is maintained to be approximately constant, and the laser beam 4 that exits from the optical fiber 8 can also maintain an approximately constant convergence, regardless of laser output level.

Meanwhile, in the foregoing explanation, the internal aperture 11 has been arranged between the rod-type solid-state laser medium 1 and the partially reflecting mirror 2; however, the internal aperture 11 may be arranged between the rod-type solid-state laser medium 1 and the totally reflecting mirror 3. Because of the symmetry in the laser beam within the resonator, that arrangement is equivalent to the case where the internal aperture 11 is arranged at the totally reflecting mirror 3's side, apart from the partially reflecting mirror 2 by the distance between the totally reflecting mirror 3 and the position of the internal aperture 11 in FIG. 10(a), i.e., the case where the internal aperture 11 is arranged at the position that is symmetric with the position of the internal aperture 11 in FIG. 10(a), with respect to the middle point 101 of the rod-type solid-state laser medium 1. For instance, in the case where, as illustrated in FIG. 10(b), the internal aperture 11 is arranged at the totally reflecting mirror 3's side, the distance La apart from the totally reflecting mirror 3, the effect of the internal aperture 11 is equivalent to that in the case where the internal aperture 11 is arranged at its position in FIG. 10(a). Thus, by, as illustrated in FIG. 10(b), arranging the optical system in the same way as that in FIG. 10(a), the same effect can be demonstrated.

In addition, the configuration in which, as described in Embodiment 2, a plane mirror is utilized as the partially reflecting mirror 2 and the internal aperture 11 limits the diameter of a laser beam within the optical resonator is not limited to be applied to a symmetric resonator configuration. It goes without saying that, as long as the aperture 5, the relay lens 6, the coupling lens 7, and the optical fiber 8 are arranged in accordance with Embodiment 2, that configuration can demonstrate the same effect, even in the case of an asymmetric resonator.

### EMBODIMENT 3

FIG. 11 is a schematic view illustrating the configuration of a rod-type solid-state laser system according to Embodiment 3 of the present invention. In Embodiment 3, by utilizing the first transfer optical system consisting of the relay lens 6 and the coupling lens 7, the endface 102 of the rod-type solid-state laser medium 1 is transferred onto the first image plane 10 and the first image plane 10 is transferred onto the incident endface 81 of the optical fiber 8. Additionally, the rod-type solid-state laser system is configured in such a way that, as is the case with Embodiments 1 and 2, the relay lens 6 is included in the second transfer optical system and transfers the aperture 5 onto the coupling lens 7.

In Embodiment 3, the aperture 5 having the same opening diameter as the diameter of the rod-type solid-state laser medium 1 is arranged at the position that, with reference to the partially reflecting mirror 2, is optically symmetric with the endface 102 of the rod-type solid-state laser medium 1. In other words, Equation (11′) is yielded.

L1=Lm (11′)

Therefore, the image-formation condition on the first image plane is given by Equation (1″).

$$\frac{1}{f 1} = \frac{1}{Lm + L 1 + L 2} + \frac{1}{L 3} \qquad ( {1}^{′′} )$$

In addition, Equation (2) that gives the image-formation condition on the incident endface 81 of the optical fiber 8 and Equation (3) that gives the image-formation condition on the coupling lens 7 can directly be applied also to Embodiment 3.

In Embodiment 3, the endface 102 of the rod-type solid-state laser medium 1 is set at the object plane, in the first transfer ontical system, i.e., the first reference plane. Although, in the case where the thermal lens changes, the beam-diameter change on the endface 102 of the rod-type solid-state laser medium 1 is slightly larger than either the beam-diameter change on the main plane of the equivalent thermal lens 9 in Embodiment 1 or the beam-diameter change at the internal aperture 11 in Embodiment 2, the beam-diameter change on the endface 102 of the rod-type solid-state laser medium 1 is smaller than the beam-diameter change at the outside of the rod-type solid-state laser medium 1, excluding the case where the internal aperture 11 or the like limits the beam diameter; moreover, it is ensured that the beam always stay inside the endface 102 of the rod-type solid-state laser medium 1. Accordingly, it is ensured that, when the diameter of a beam outputted from rod-type solid-state laser medium 1 becomes the same as the maximal anticipatable beam diameter, on the rod endface 102 as an object plane, i.e., the diameter of the rod-type solid-state laser medium 1, the diameter of the beam formed, by means of the first transfer optical system, on the incident endface 81 of the optical fiber 8 always stays within the maximal allowable diameter of a beam formed on the incident endface 81. As a result, even in the case where the thermal lens of the rod-type solid-state laser medium 1 changes, the laser beam 4 can always be kept inside the core of the optical fiber 8.

Additionally, the aperture 5 is arranged on the second reference plane that is optically symmetric with the endface 102, of the rod-type solid-state laser medium 1, that is the first reference plane, with respect to the partially reflecting mirror 2; therefore, it is ensured that, because of the symmetry in beam propagation, the beam diameter at the aperture 5 is always smaller than the diameter of the rod-type solid-state laser medium 1. Moreover, the opening diameter of the aperture 5 is set to be the same as the diameter of the rod-type solid-state laser medium 1; therefore, it is ensured that, even in the case where pointing fluctuation occurs in the laser beam 4, the beam on the coupling lens 7 is always kept at the same position, and the beam diameter is always smaller than the constant value decided by the opening diameter of the aperture 5 and the transfer magnification of the second transfer optical system. As a result, regardless of the condition of the thermal lens of the rod-type solid-state laser medium 1, the collection angle of the laser beam 4 that enters the optical fiber 8 is always maintained to be smaller than a constant value, and the laser beam 4 that exits from the optical fiber 8 can maintain a convergence of larger than a constant value.

### EMBODIMENT 4

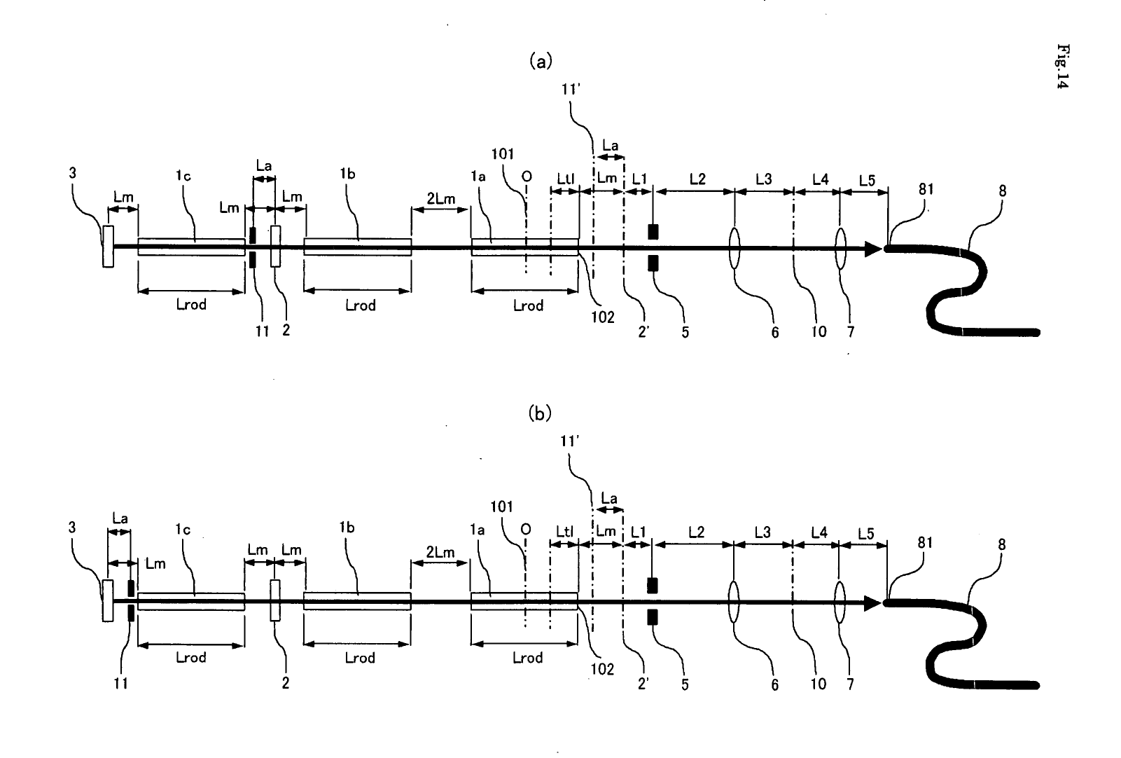

FIG. 12 (a) is a schematic view illustrating the configuration of a rod-type solid-state laser system according to Embodiment 4 of the present invention. In FIG. 12(a), Reference Character 1a designates a first rod-type solid-state laser medium arranged in an optical resonator configured of the partially reflecting mirror 2 formed of a plane mirror and the totally reflecting mirror 3; and Reference Character 1b designates a second rod-type solid-state laser medium. The first and second rod-type solid-state laser media 1a and 1b each have a length of Lrod. In addition, in Embodiment 4, by setting the distance between the partially reflecting mirror 2 and the first rod-type solid-state laser medium 1a to be Lm, the distance between the first rod-type solid-state laser medium 1a and the second rod-type solid-state laser medium 1b to be 2 Lm, and the distance between the second rod-type solid-state laser medium 1b and the totally reflecting mirror 3 to be Lm, a so-called periodic resonator is configured. Accordingly, under the ideal condition that the first and second solid-state laser media 1a and 1b are evenly pumped, the respective diameters, i.e., mode shapes of a laser beam in the first and second solid-state laser media 1a and 1b are the same as the mode shape of a laser beam in a symmetric stable optical resonator configured by utilizing a single rod-type solid-state laser medium, for example, illustrated in FIG. 6. In other words, a periodic resonator configured of a plurality of rod-type solid-state laser media 1 readily enables the output power to be raised, with the convergence maintained to be constant.

Also in Embodiment 4, the aperture 5, the relay lens 6, the coupling lens 7, and the incident endface 81 of the optical fiber 8 are arranged in accordance with the same criterion as that in Embodiment 1. That is to say, the main plane of the equivalent thermal lens 9, situated at the position that is a distance Ltl apart from the endface 102 of the rod-type solid-state laser medium 1a, is set to be the first reference plane, and the aperture 5 having the same opening diameter as the diameter of the rod-type solid-state laser medium 1a is arranged at the position that, with reference to the partially reflecting mirror 2, is optically symmetric with the first reference plane. The first transfer optical system is configured of the relay lens 6 and the coupling lens 7; the relay lens 6 transfers the main plane of the equivalent thermal lens 9 onto the first image plane 10; and the coupling lens 7 transfers the first image plane 10 onto the incident endface 81 of the optical fiber 8. Additionally, the second transfer optical system is formed of the relay lens 6; and the relay lens 6 transfers the aperture 5 onto the coupling lens 7.

As described in Embodiment 4, even in the case where, by arranging a plurality of solid-state laser media 1 in a single optical resonator, a periodic resonator is configured, as long as the aperture 5, the relay lens 6, the coupling lens 7, and the incident endface 81 of the optical fiber 8 are arranged in the same way as that in Embodiment 1, not only the same effect as that of Embodiment 1 can be demonstrated, but also the output power can readily be raised, with the convergence maintained to be approximately constant.

In addition, in Embodiment 4, a configuration has been described in which two rod-type solid-state laser media 1a and 1b are arranged in a single optical resonator; however, the number of rod-type solid-state laser media 1 to be arranged in the optical resonator is not limited to two. For example, by selecting the number of the rod-type solid-state laser media 1 to be arranged in the optical resonator, in accordance with a desired laser output, setting to be Lm the respective distances between the partially reflecting mirror 2 and its neighboring rod-type solid-state laser medium 1 and between the totally reflecting mirror 3 and its neighboring rod-type solid-state laser medium 1, and setting to be 2 Lm the distance between the rod-type solid-state laser media 1 that oppose each other, a periodic resonator can be configured, regardless of the number of the rod-type solid-state laser media 1.

In addition, in Embodiment 4 in which a plurality of rod-type solid-state laser media 1 is arranged in a single optical resonator, a configuration has been described in which, as is the case with Embodiment 1, the main plane of the equivalent thermal lens 9 of the rod-type solid-state laser medium 1a adjacent to the partially reflecting mirror 2 is set to be the object plane in the first transfer optical system; however, the object plane in the first transfer optical system is not limited to the main plane of the equivalent thermal lens 9. For example, in a configuration in which, as illustrated in FIG. 12(b), the internal aperture 11 is provided in an optical resonator, as is the case with Embodiment 2, by setting the internal aperture 11 to be the object plane of the first transfer optical system, i.e., the first reference plane, the same effect as that of Embodiment 2 can be demonstrated. The case where, unlike FIG. 12(b), the internal aperture 11 is arranged between the rod-type solid-state laser medium 1b and the totally reflecting mirror 3 may be considered to be equivalent to the case where, as described in Embodiment 2, the internal aperture 11 is arranged at the position that is symmetric with the position of the internal aperture 11 in FIG. 12(b), with respect to the middle point 101 of the rod-type solid-state laser medium. Moreover, as is the case with Embodiment 3, by setting the endface 102 of the rod-type solid-state laser medium 1a adjacent to the partially reflecting mirror 2 to be the object plane of the first transfer optical system, i.e., the first reference plane, the same effect as that of Embodiment 3 can be demonstrated. The point is that the rod-type solid-state laser system may be configured in such a way that, as the first reference plane, the object plane of the first transfer optical system consisting of the relay lens 6 and the coupling lens 7 is set at an appropriate position inside the optical resonator, whereby the object plane is transferred onto the first image plane, by means of the relay lens 6, and the first image plane is relayed by means of coupling lens 7 to the incident endface 81 of the optical fiber 8, in a contraction transfer fashion, and the aperture 5 is provided at the position that, with respect to the partially reflecting mirror 2, is optically symmetric with the object plane, of the first transfer optical system, set in the optical resonator, whereby the aperture 5 as the object plane of the second transfer optical system is transferred by means of the second transfer optical system formed of the relay lens 6 onto the coupling lens 7.

### EMBODIMENT 5

FIG. 13 is a schematic view illustrating the configuration of a rod-type solid-state laser system according to Embodiment 5 of the present invention. In Embodiment 5, a so-called MOPA (Master Oscillator Power Amplifier) configuration is employed in which three rod-type solid-state laser media 1a, 1b, and 1c are utilized, only the rod-type solid-state laser medium 1c is arranged in an optical resonator consisting of the partially reflecting mirror 2 and the totally reflecting mirror 3, whereby an oscillator is configured that is utilized to generate laser beams, and the first and second rod-type solid-state laser media 1a and 1b are utilized as amplifiers that amplify a laser beam generated by the oscillator. In Embodiment 5, the rod-type solid-state laser media 1a, 1b, and 1c are arranged each spaced a distance 2 Lm apart from one another. In addition, the partially reflecting mirror 2 formed of a plane mirror is arranged at the middle point between the second rod-type solid-state laser medium 1b and the third rod-type solid-state laser medium 1c, and the totally reflecting mirror 3 formed of a plane mirror is arranged at the point that is a distance Lm apart from the third rod-type solid-state laser medium 1c. As described in Embodiment 5, in a rod-type solid-state laser system utilizing a plurality of rod-type solid-state laser media 1, by employing a periodic MOPA configuration in which, the plurality of rod-type solid-state laser media 1 is arranged each spaced a distance 2 Lm apart from one another, the totally reflecting mirror 3 is provided at the position that is a distance Lm apart from the endface of the rod-type solid-state laser medium 1 arranged at an endmost position, and the partially reflecting mirror 2 is provided at the middle position between the two arbitrary rod-type solid-state laser media 1, the periodicity of the mode shape within each rod-type solid-state laser medium 1 is maintained, as is the case with the foregoing periodic resonator, under the ideal condition that all the rod-type solid-state laser media 1 are evenly pumped. Thus, the use of the periodic MOPA configuration, described in Embodiment 5, utilizing a plurality of rod-type solid-state laser media 1 readily enables the output power to be raised, with the convergence maintained to be approximately constant. The periodic MOPA configuration is common among rod-type solid-state laser systems utilizing a plurality of rod-type solid-state laser media 1; the respective numbers of the rod-type solid-state laser media 1 provide in the optical resonator and the rod-type solid-state laser media 1 utilized as the amplifiers may be selected in accordance with the desired performance.

Next, a method, of arranging optical systems, for Embodiment 5, i.e., the periodic MOPA configuration, will be explained. In the periodic MOPA configuration, a third reference plane 2′ is set at the position that is apart from the endface 102, of the last-stage rod-type solid-state laser medium 1a, from which the laser beam 4 exits, by a distance Lm, which is half of the distance 2 Lm by which the rod-type solid-state laser media 1a, 1b, and 1c are each spaced from one another. The aperture 5 having the same opening diameter as the diameter of the rod-type solid-state laser medium 1a is provided at the position that, with reference to the third reference plane 2′, is symmetric with the main plane of the equivalent thermal lens 9 of the rod-type solid-state laser medium 1a, i.e., the second reference plane. In other words, the third reference plane plays the same role as each of the partially reflecting mirrors in Embodiments 1 to 4 does, in setting the second reference plane; therefore, the third reference plane is referred to as a virtual partially reflecting mirror. As is the case with Embodiment 1, the first transfer optical system is configured of the relay lens 6 and the coupling lens 7; in the first place, the relay lens 6 transfers the main plane of the equivalent thermal lens 9 of the rod-type solid-state laser medium la onto the first image plane 10 and the coupling lens 7 relays in a contraction transfer fashion the first image plane 10 to the incident endface 81 of the optical fiber 8. Additionally, the relay lens 6 is included in the second transfer optical system; the relay lens 6 transfers the aperture 5 onto the coupling lens 7. Therefore, Equation (1) to (3) described in Embodiment 1 can directly be applied to Embodiment 5.

Also in the periodic MOPA configuration, the periodicity of a mode shape in the rod-type solid-state laser medium 1 is maintained to be approximately constant; therefore, if the aperture 5, the relay lens 6, the coupling lens 7, and the incident endface 81 of the optical fiber 8 are arranged in the same way as that in Embodiment 1, not only the same effect as that of Embodiment 1 can be demonstrated, but also the output power can readily be raised, with the convergence maintained to be approximately constant. In addition, compared with the periodic MOPA configuration described in Embodiment 5, the periodic resonator configuration described in Embodiment 4 has an advantage that, because all the rod-type solid-state laser media 1 are arranged within the optical resonator, the proportion of the spontaneously emitted light to the laser beam 4 to be extracted is small, and the position of the beam waist is fixed in accordance with the boundary conditions for the optical resonators, a laser beam having high-level convergence can readily be generated. On the other hand, the periodic resonator configuration has an inherent disadvantage that, because a plurality of rod-type solid-state laser media 1 are arranged in the optical resonator, the stability condition for the optical resonator is readily disrupted and unstable oscillation is liable to occur, due to unevenness, in the pumping conditions, among the rod-type solid-state laser media 1. The periodic MOPA configuration has a disadvantage that, because spontaneously emitted light generated from the amplifier is readily amplified, whereby the proportion of the spontaneously emitted light to the laser beam 4 increases and the position of the beam waist is not fixed, in accordance with the boundary conditions for the optical resonators, the convergence can readily be deteriorated. Moreover, the periodic MOPA configuration has a disadvantage that, because the low-intensity laser beam 4 cannot sufficiently be amplified, the efficiency in generating a laser beam is reduced. On the other hand, the periodic MOPA configuration has a advantage that, because, even in the case where as many rod-type solid-state laser media 1 as the optical resonators are utilized, the number of the rod-type solid-state laser media 1 to be arranged in the optical resonator can be reduced, the laser beam 4 can stably be generated, even in the case where unevenness, in the pumping conditions, among the rod-type solid-state laser media 1.

In addition, in Embodiment 5, a configuration has been described in which the main plane of the equivalent thermal lens 9 of the rod-type solid-state laser medium 1a situated at the laser-beam emitting end is set to be the object plane, in the first transfer optical system, i.e., the first reference plane; however, the object plane in the first transfer optical system is not limited to the main plane of the equivalent thermal lens 9. For example, if, as is the case with Embodiment 3, a configuration is employed in which the aperture 5 having the same opening diameter as the diameter of the rod-type solid-state laser medium 1a is provided at the position that, with reference to the virtual partially reflecting mirror 2′, is symmetric with the endface 102 of the rod-type solid-state laser medium 1a situated at the laser-beam emitting end, i.e., the second reference plane, and the endface 102 of the rod-type solid-state laser medium 1a is set to be the object plane of the first transfer optical system, i.e., the first reference plane, and transfer-relayed to the incident endface 81 of the optical fiber 8, the same effect as that of Embodiment 3 can be demonstrated.

In addition, in the foregoing description, a method has been explained in which the main plane of the equivalent thermal lens 9, or endface 102, of the rod-type solid-state laser medium 1a is set to be the object plane, in the first transfer optical system, i.e., the first reference plane; however, the object plane in the first transfer optical system is not limited to the main plane of the equivalent thermal lens 9 or the endface 102. For instance, even in the case where, within the range between the endface 102 of the rod-type solid-state laser medium 1a and the middle point 101, the thermal-lens main plane as the first reference plane is arbitrarily set, the same effect can be demonstrated. The point is that if a configuration is employed in which the aperture 5 having the same opening diameter as the diameter of the internal aperture 1 is arranged at the position that, with reference to the virtual partially reflecting mirror 2′, is optically symmetric with the position, to be set, of the main plane of the equivalent thermal lens, the main plane of the equivalent thermal lens 9 is transfer-relayed by means of the first transfer optical system consisting of the relay lens 6 and the coupling lens 7 to the incident endface 81 of the optical fiber 8, and the aperture 5 is transferred by means of the second transfer optical system formed of the relay lens 6 onto the coupling lens 7, the beam diameter and the beam position on the coupling lens 7 are maintained to be approximately constant and the beam diameter and the beam position on the incident endface 81 of the optical fiber 8 are ensured, whereby stable beam transmission through the optical fiber 8 is enabled and the laser beam 4 that exits from the optical fiber 8 can maintain its convergence to be approximately constant, even in the case where the thermal lens of the rod-type solid-state laser medium 1 changes or pointing fluctuation occurs in the laser beam 4.

### EMBODIMENT 6

FIG. 14 (a) is a schematic view illustrating the configuration of a rod-type solid-state laser system according to Embodiment 6 of the present invention. As is the case with Embodiment 5, in Embodiment 6, a plurality of the rod-type solid-state laser media 1a, 1b, and 1c are arranged each spaced evenly apart from one another so that a periodic MOPA configuration is employed. In addition, in Embodiment 6, the internal aperture 11 is inserted into an optical resonator, configured of the partially reflecting mirror 2 and the totally reflecting mirror 3, so as to limit the diameter of the laser beam 4. Because, also in the rod-type solid-state laser media 1b and 1c that are utilized as amplifiers, the amplification action is applied to the laser beam 4, only within the portions, of the rod-type solid-state laser media 1b and 1c, through which the laser beam 4 passes, the mode shape within the first rod-type solid-state laser medium 1a is maintained even in the amplifiers. In Embodiment 6, the internal aperture 11 is provided at the position that is a distance La apart from the partially reflecting mirror 2.

Next, a method of arranging optical systems, for Embodiment 6, will be explained. In the first place, as is the case with Embodiment 5, it is assumed that the virtual partially reflecting mirror 2′ is arranged at the position that is a distance Lm apart from the endface 102 of the last-stage rod-type solid-state laser medium 1a from which the laser beam 4 exits. Next, the position that is apart from the virtual partially reflecting mirror 2′ by a distance La in the direction toward the first rod-type solid-state laser medium 1a is set as the first reference plane, and it is assumed that a virtual internal aperture 11′ is arranged at the first reference plane. The position that, with reference to the virtual partially reflecting mirror 2′, is optically symmetric with the virtual internal aperture 11′ is set as the second reference plane, and the aperture 5 having the same opening diameter as the diameter of the internal aperture 11 is arranged at the second reference plane. Accordingly, Equation (11) described in Embodiment 2 can be applied also to the periodic MOPA configuration. As is the case with Embodiment 1, the first transfer optical system is configured of the relay lens 6 and the coupling lens 7; in the first place, the relay lens 6 transfers the virtual internal aperture onto the first image plane 10 and the coupling lens 7 relays in a contraction transfer fashion the first image plane 10 to the incident endface 81 of the ontical fiber 8. Additionally, the relay lens 6 is included in the second transfer optical system; the relay lens 6 transfers the aperture 5 onto the coupling lens 7. Therefore, Equation (1′) described in Embodiment 2, and Equations (2) to (3) described in Embodiment 2 can be applied also to Embodiment 6.

In addition, unlike FIG. 14(a), the case where, as illustrated in FIG. 14(b), the internal aperture 11 is arranged between the rod-type solid-state laser medium 1c and the totally reflecting mirror 3 may be considered to be equivalent to the case where, as described in Embodiment 2, the internal aperture 11 is arranged at the totally reflecting mirror 3's side, apart from the partially reflecting mirror 2 by the distance between the totally reflecting mirror 3 and the position of the internal aperture 11 in FIG. 14(a). In other words, in the case where the internal aperture 11 is arranged at the position that is a distance La apart from the totally reflecting mirror 3, the arrangement of the optical systems may be decided, as illustrated in FIG. 14(b), in the same way as that in FIG. 14(a).

As described in Embodiment 6, also in a method in which, in the periodic MOPA configuration, the internal aperture 11 is inserted into the optical resonator so as to limit the beam diameter, the periodicity of a mode shape in the rod-type solid-state laser medium 1 is maintained to be approximately constant; therefore, not only the same effect as that of Embodiment 2 can be demonstrated, but also the output power can readily be raised, with the convergence maintained to be constant.

In addition, in Embodiment 6, a configuration has been described in which the internal aperture 11 is inserted only into the optical resonator so as to limit the beam diameter; however, in addition to the internal aperture 11 inserted into the optical resonator, an aperture for limiting the beam diameter may be provided in the vicinity of any one of the rod-type solid-state laser media 1 to be utilized as amplifiers. For example, if an actual aperture having approximately the same opening diameter as the diameter of the internal aperture 11 is provided at the position where the virtual internal aperture 11′ is set, the effects of beam-pointing fluctuation caused in the rod-type solid-state laser medium utilized as an amplifier and spontaneously emitted and amplified light that deteriorates the quality of the laser beam 4 are suppressed, whereby it is possible to transmit the laser beam 4, by means of the further stable and high-reliability optical fiber 8.

Moreover, in the foregoing explanation, a configuration has been described in which, as a rod-type solid-state laser medium, a Nd(neodymium)-doped YAG (yttrium-aluminum garnet) crystal is utilized; however, it goes without saying that the type of the solid-state laser medium is not limited to a Nd-doped YAG crystal, and, for example, even in the case where a phosphate glass or a vanadate crystal is utilized, the same effect can be demonstrated.

### INDUSTRIAL APPLICABILITY

A rod-type solid-state laser system according to the present invention is suitable for a system that transmits a laser beam through an optical fiber and implements machining.

1-24. (canceled)

25. A rod-type solid-state laser system in which, by means of a relay lens and a coupling lens, a laser beam emitted from a symmetric stable optical resonator consisting of a rod-type solid-state laser medium, a partially reflecting mirror, and a totally reflecting mirror is made to enter an optical fiber, a first reference plane is set at an arbitrarily position between the endface, of the rod-type solid-state laser medium arranged close to the partially reflecting mirror, that opposes the partially reflecting mirror and the middle point of the rod-type solid-state laser medium, a second reference plane is set at a position that is optically symmetric with the first reference plane, with respect to the partially reflecting mirror, the relay lens is arranged at a position at which the relay lens transfers the first reference plane onto a first image plane and transfers the second reference plane onto the coupling lens, and the coupling lens is arranged at a position at which the coupling lens transfers the first image plane onto the endface of the optical fiber.

26. The rod-type solid-state laser system according to claim 25, wherein a thin-wall lens is assumed that is optically equivalent to a thermal lens formed at a position between the endface, of the rod-type solid-state laser medium arranged close to the partially reflecting mirror, that opposes the partially reflecting mirror and the middle point of the rod-type solid-state laser medium, and the first reference plane is set at the position of the main plane of the assumed thin-wall lens.

27. The rod-type solid-state laser system according to claim 25, wherein the first reference plane is set on the endface, of the rod-type solid-state laser medium arranged close to the partially reflecting mirror, that opposes the partially reflecting mirror.

28. The rod-type solid-state laser system according to claim 25, wherein an aperture is arranged at the position of the second reference plane.

29. The rod-type solid-state laser system according to claim 28, wherein the opening diameter of the aperture is approximately the same as the diameter of the rod-type solid-state laser medium.

30. The rod-type solid-state laser system according to claim 25, wherein the rod-type solid-state laser medium is singular.

31. The rod-type solid-state laser system according to claim 25, comprising at least one more rod-type solid-state laser media.

32. A rod-type solid-state laser system in which, by means of a relay lens and a coupling lens, a laser beam emitted from a symmetric stable optical resonator consisting of a rod-type solid-state laser medium, a totally reflecting mirror, a partially reflecting mirror formed of a plane mirror, and a is made to enter an optical fiber, wherein a first reference plane is set at a position, between the partially reflecting mirror and the middle point of the rod-type solid-state laser medium arranged close to the partially reflecting mirror, at which the diameter of a laser beam is constant, regardless of the condition of the thermal lens of the rod-type solid-state laser medium, a second reference plane is set at a position that is optically symmetric with the first reference plane, with respect to the partially reflecting mirror, the relay lens is arranged at a position at which the relay lens transfers the first reference plane onto a first image plane and transfers the second reference plane onto the coupling lens, and the coupling lens is arranged at a position at which the coupling lens transfers the first image plane onto the endface of the optical fiber.

33. The rod-type solid-state laser system according to claim 32, wherein an internal aperture for limiting the diameter of a laser beam is provided at a position between the rod-type solid-state laser medium and the partially reflecting mirror, and the first reference plane is set at the position of the internal aperture.

34. The rod-type solid-state laser system according to claim 32, wherein an internal aperture for limiting the diameter of a laser beam is provided at a position between the rod-type solid-state laser medium and the totally reflecting mirror, and the first reference plane is set at a position that, toward the rod-type solid-state laser medium, is apart from the partially reflecting mirror by the same distance as that between the internal aperture and the totally reflecting mirror.

35. The rod-type solid-state laser system according to claim 32, wherein an aperture is arranged at the position of the second reference plane.

36. The rod-type solid-state laser system according to claim 35, wherein the opening diameter of the aperture is approximately the same as the opening diameter of the internal aperture.

37. The rod-type solid-state laser system according to claim 32, wherein the rod-type solid-state laser medium is singular.

38. The rod-type solid-state laser system according to claim 32, comprising at least one more rod-type solid-state laser media.

39. A rod-type solid-state laser system in which rod-type solid-state laser media are provided each spaced evenly apart from one another, a totally reflecting mirror formed of a plane mirror is arranged at a position that is apart from the outer endface of the rod-type solid-state laser medium arranged at an endmost position, by approximately half the distance by which the rod-type solid-state laser media are each spaced apart from one another, a partially reflecting mirror formed of a plane mirror is arranged at the approximately middle position between two arbitrary neighboring ones of the rod-type solid-state laser media, thereby configuring an optical resonator defined by the totally reflecting mirror and the partially reflecting mirror, a laser beam emitted from the optical resonator is amplified by the rod-type solid-state laser media, utilized as amplifiers, other than the rod-type solid-state laser medium utilized for the optical resonator, and by means of a relay lens and a coupling lens, the laser beam is made to enter an optical fiber, wherein a virtual partially reflecting mirror is assumed at a position that is apart from the emitting-side endface of the rod-type solid-state laser medium situated at the laser-beam emitting end, by approximately half the distance by which the rod-type solid-state laser media are each spaced apart from one another, a first reference plane is set at an arbitrary position between the endface, of the rod-type solid-state laser medium arranged close to the virtual partially reflecting mirror, that opposes the virtual partially reflecting mirror and the middle point of said rod-type solid-state laser medium, a second reference plane is set at a position that is optically symmetric with the first reference plane, with respect to the virtual partially reflecting mirror, the relay lens is arranged at a position at which the relay lens transfers the first reference plane onto a first image plane and transfers the second reference plane onto the coupling lens, and the coupling lens is arranged at a position at which the coupling lens transfers the first image plane onto the endface of the optical fiber.

40. The rod-type solid-state laser system according to claim 39, wherein a thin-wall lens is assumed that is optically equivalent to a thermal lens formed at a position between the endface of the rod-type solid-state laser medium arranged close to the virtual partially reflecting mirror, that opposes the virtual partially reflecting mirror and the middle point of said rod-type solid-state laser medium, and the first reference plane is set at the position of the main plane of the assumed thin-wall lens.

41. The rod-type solid-state laser system according to claim 39, wherein the first reference plane is set on the endface, of the rod-type solid-state laser medium arranged close to the virtual partially reflecting mirror, that opposes the virtual partially reflecting mirror.

42. The rod-type solid-state laser system according to claim 39, wherein an aperture is arranged at the position of the second reference plane.

43. The rod-type solid-state laser system according to claim 42, wherein the opening diameter of the aperture is approximately the same as the diameter of the rod-type solid-state laser medium.

44. A rod-type solid-state laser system in which rod-type solid-state laser media are provided each spaced evenly apart from one another, a totally reflecting mirror formed of a plane mirror is arranged at a position that is apart from the outer endface of the rod-type solid-state laser medium arranged at an endmost position, by approximately half the distance by which the rod-type solid-state laser media are each spaced apart from one another, a partially reflecting mirror formed of a plane mirror is arranged at the approximately middle position between two arbitrary neighboring ones of the rod-type solid-state laser media, thereby configuring an optical resonator defined by the totally reflecting mirror and the partially reflecting mirror, a laser beam emitted from the optical resonator is amplified by the rod-type solid-state laser media, utilized as amplifiers, other than the rod-type solid-state laser medium utilized for the optical resonator, and by means of a relay lens and a coupling lens, the laser beam is made to enter an optical fiber, wherein a virtual partially reflecting mirror is assumed at a position that is apart from the emitting-side endface of the rod-type solid-state laser medium situated at the laser-beam emitting end, by approximately half the distance by which the rod-type solid-state laser media are each spaced apart from one another, a first reference plane is set at a position, between the virtual partially reflecting mirror and the middle point of the rod-type solid-state laser medium arranged close to the virtual partially reflecting mirror, at which the diameter of a laser beam is constant, regardless of the condition of the thermal lens of the rod-type solid-state laser medium, a second reference plane is set at a position that is optically symmetric with the first reference plane, with respect to the virtual partially reflecting mirror, the relay lens is arranged at a position at which the relay lens transfers the first reference plane onto a first image plane and transfers the second reference plane onto the coupling lens, and the coupling lens is arranged at a position at which the coupling lens transfers the first image plane onto the endface of the optical fiber.

45. The rod-type solid-state laser system according to claim 44, wherein an internal aperture for limiting the diameter of a laser beam is provided at a position between the rod-type solid-state laser medium, in the optical resonator, arranged close to the partially reflecting mirror and the partially reflecting mirror, and the first reference plane is set at a position that, toward the rod-type solid-state laser medium, is apart from the virtual partially reflecting mirror by the same distance as that between the internal aperture and the partially reflecting mirror.

46. The rod-type solid-state laser system according to claim 44, wherein an internal aperture for limiting the diameter of a laser beam is provided at a position between the rod-type solid-state laser medium, in the optical resonator, arranged close to the totally reflecting mirror and the totally reflecting mirror, and the first reference plane is set at a position that, toward the rod-type solid-state laser medium, is apart from the virtual partially reflecting mirror by the same distance as that between the internal aperture and the totally reflecting mirror.

47. The rod-type solid-state laser system according to claim 44, wherein an aperture is arranged at the position of the second reference plane.

48. The rod-type solid-state laser system according to claim 47, wherein the opening diameter of the aperture is approximately the same as the opening diameter of the internal aperture.
